(19) United States
(12) Patent Application Publication
(10) Pub. No.: US 2026/0050741 A1
(43) Pub. Date: Feb. 19, 2026

(54) ENTITY EXTRACTION BASED ON EDGE COMPUTING

(71) Applicant: Microsoft Technology Licensing, LLC, Redmond, WA (US)

(72) Inventors: Linjun SHOU, Haidian (CN); Bo SHAO, Redmond, WA (US); Qiang SHEN, Redmond, WA (US); Gen LI, Redmond, WA (US); Tianqiao LIU, Redmond, WA (US); Jingxia XING, Redmond, WA (US)

(21) Appl. No.: 19/103,459

(22) PCT Filed: Sep. 21, 2023
(86) PCT No.: PCT/US2023/033418

§ 371 Date: Feb. 12, 2025

(30) Foreign Application Priority Data
Oct. 25, 2022 (CN) 202211310229.6

(51) Int. Cl. G06F 40/284; G06F 40/295

(52) U.S. Cl. CPC G06F 40/284; G06F 40/295

(57) ABSTRACT

The present disclosure proposes a method, an apparatus and a computer program product for entity extraction based on edge computing. A web document may be obtained. A text feature of the web document may be identified. A visual feature corresponding to the text feature may be identified. An entity type sequence corresponding to the web document may be extracted based on the text feature and the visual feature.

### BACKGROUND

Entity Extraction (EE) is also known as Named Entities Recognition (NER), with its main task to identify the text range of an entity and classify the entity into predefined types, e.g., person name, place name, date etc. The entity extraction may be performed through a machine learning model. Herein, a machine learning model used to perform the entity extraction task is referred to as an entity extraction model. The entity extraction task may be defined as a sequence labeling task. The entity extraction model may infer the input text or text features and output the corresponding entity type sequence.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter. Embodiments of the present disclosure propose a method, an apparatus and a computer program product for entity extraction based on edge computing. A web document may be obtained. A text feature of the web document may be identified. A visual feature corresponding to the text feature may be identified. An entity type sequence corresponding to the web document may be extracted based on the text feature and the visual feature.

It should be noted that the above one or more aspects include features as detailed in the following and specifically pointed out in the claims. The following description and the appended drawings set forth in detail certain illustrative features of the one or more aspects. These features are only indicative of the various ways in which the principles of various aspects may be employed, and this disclosure is intended to include all such aspects and their equivalent transformations.

### BRIEF DESCRIPTION OF THE DRAWINGS

The disclosed aspects will hereinafter be described in conjunction with the appended drawings that are provided to illustrate and not to limit the disclosed aspects.

FIG. 1 illustrates an exemplary process for entity extraction based on edge computing according to an embodiment of the present disclosure.

FIG. 2 illustrates a schematic diagram of an exemplary token sequence and corresponding entity type sequence according to an embodiment of the present disclosure.

FIG. 3 illustrates another exemplary process for entity extraction based on edge computing according to an embodiment of the present disclosure.

FIG. 4 illustrates an exemplary process for obtaining a target entity extraction model according to an embodiment of the present disclosure.

FIG. 5 illustrates an exemplary process for performing model enhancement on a complex language model according to an embodiment of the present disclosure.

FIG. 6 illustrates an exemplary process for performing visual and text joint pretraining through node relation prediction pretraining task according to an embodiment of the present disclosure.

FIG. 7 illustrates an exemplary process for performing cross lingual fine-tuning through attribute augmentation according to an embodiment of the present disclosure.

FIG. 8 illustrates an exemplary process for performing cross lingual fine-tuning through self-training based on iterative knowledge distillation according to an embodiment of the present disclosure.

FIG. 9 illustrates an exemplary process for performing self-training based on iterative knowledge distillation according to an embodiment of the present disclosure.

FIG. 10 illustrates an exemplary process for performing model compression with a reference entity extraction model and a lightweight language model according to an embodiment of the present disclosure.

FIG. 11 illustrates an exemplary process for performing representation fusion based knowledge distillation according to an embodiment of the present disclosure.

FIG. 12 illustrates an exemplary process for labeling a web document sample through a teacher model according to an embodiment of the present disclosure.

FIG. 13 illustrates an exemplary process for reducing a model vocabulary of a lightweight entity extraction model according to an embodiment of the present disclosure.

FIG. 14 is a flowchart of an exemplary method for entity extraction based on edge computing according to an embodiment of the present disclosure.

FIG. 15 illustrates an exemplary apparatus for entity extraction based on edge computing according to an embodiment of the present disclosure.

FIG. 16 illustrates another exemplary apparatus for entity extraction based on edge computing according to an embodiment of the present disclosure.

### DETAILED DESCRIPTION

The present disclosure will now be discussed with reference to several exemplary implementations. It is to be understood that these implementations are discussed only for enabling those skilled in the art to better understand and thus implement the embodiments of the present disclosure, rather than suggesting any limitations on the scope of the present disclosure.

People may retrieve, access or browse web information they are interested in, e.g., web page, picture, video, etc., through a browser. It is desirable to provide some additional functionality through the browser to improve user experience. For example, when people view an item of product on an online shopping website through a browser, if the price of the product on different shopping websites may be listed, or the price change curve of the product in a recent period is displayed, it may be helpful for people to determine whether the current price of the product on the current shopping website is reasonable. These additional functions may be implemented through extracting expected entity types, e.g., product name, price, manufacturer, etc., from web documents through entity extraction techniques. Herein, a web document refers to a web-based document. A web document may be opened through a browser, regardless of whether the browser is connected to a network or not. In order to reduce the latency of performing entity extraction and enhance privacy protection for the user, it is desirable to perform the entity extraction on a client device of the user. Herein, a client device refers to any computing device capable of being operated by an end user, including, e.g., a desktop computer, a laptop computer, a tablet computer, a cellular phone, a wearable device, etc. It may be considered to deploy an entity extraction model in a browser installed on a client device and perform entity extraction through the entity extraction model. However, deploying an entity extraction model that is able to meet the requirements of accuracy, real-time performance, etc. in browsers faces many challenges. For example, users of browsers are in many countries. This requires the entity extraction model can support multiple languages, however, except for languages such as English. French, and German that have rich training resources, training resources for other languages are scarce. This limits the performance of entity extraction models when performing entity extraction tasks for languages with scarce training resources. Additionally, web documents of different websites are quite different, and key attribute information may be distributed in different locations of the web documents, thus it is required to consider the entire document. A long input sequence may lead to long inference latency, especially for a model based on a transformer layer structure. Additionally, an entity extraction model deployed in a browser should be low-latency and not excessively occupy computing resources and storage resources of the client device. However, existing machine learning models with good performance are usually complex models with huge number of parameters. Such models cannot be deployed directly on client devices.

Embodiments of the present disclosure propose entity extraction based on edge computing. Edge computing may refer to computing performed at the edge of the network that is close to data input or user. For example, computing performed at a client device of an end user may be considered as edge computing. Entity extraction according to the embodiments of the present disclosure may be performed at a client device. A web document may be obtained at a client device, and a text feature of the web document and a visual feature corresponding to the text feature may be identified. A text feature may include a token sequence extracted from the web document and the location of each token of the token sequence in the token sequence. Herein, a token refers to the basic language unit that constitutes texts in different languages. A visual feature corresponds to a text feature, and may include visual information corresponding to each token in the token sequence, including e.g., location information, font shape information, font size information, font color information, etc. An entity type sequence corresponding to the web document may be extracted based on the text feature and the visual feature. Existing entity extraction techniques only consider text features. Embodiments of the present disclosure propose to consider both text features and visual features of a web document when performing entity extraction for the web document, so as to obtain more accurate entity extraction results. Taking price extraction as an example, a web page sometimes contains multiple prices, e.g., previous prices, current prices, prices for members, etc. These prices may have different visual features, e.g., different colors, different font sizes, etc. When performing price extraction, considering both text features and visual features enables more accurate extraction of desired prices.

The entity extraction process described above may be performed through an entity extraction model deployed on the client device. Herein, a machine learning model deployed on a client device to perform the entity extraction task is referred to as a target entity extraction model. The target entity extraction model is a lightweight model. A target entity extraction model may be obtained through a multi-stage training process according to an embodiment of the present disclosure. First, a complex language model may be obtained. Subsequently, model enhancement may be performed on the complex language model so that it can be used for performing an entity extraction task. Herein, a complex model capable of performing an entity extraction task is referred to as a reference entity extraction model. A lightweight language model may be obtained. The lightweight language model may be a model having a lower complexity than the complex language model. Then, model compression may be performed with the reference entity extraction model and the lightweight language model to obtain the target entity extraction model.

Model enhancement may include visual and text joint pretraining. Visual and text joint pretraining aims to enable the trained model to perform entity extraction for a web document with both text features and visual features of the web document. In particular, embodiments of the present disclosure propose to perform visual and text joint pretraining through a node relation prediction pretraining task. A document object model (DOM) tree corresponding to the web document may be constructed, and a text node set may be extracted from the document object model tree. The node relation prediction pretraining task enables the model to better understand the structure of the document object model tree of a web document through modeling the node relation, and to further obtain accurate entity extraction results.

Model enhancement may further include cross lingual fine-tuning. Cross lingual fine-tuning aims to improve the performance of models when performing entity extraction tasks for languages with scarce training resources. Embodiments of the present disclosure propose to perform cross lingual fine-tuning through attribute augmentation, self-training based on iterative knowledge distillation, etc. Attribute augmentation aims to augment the training dataset of the scarce training resource language through replacing attribute values of the training samples of the scarce training resource language. A model trained with an augmented training dataset is more robust when performing an entity extraction task for the scarce training resource language. Self-training based on iterative knowledge distillation aims to optimize two models through performing multiple rounds of self-training process on these two models. In each round, the first model may be regarded as the teacher model through knowledge distillation, and its labeled training data may be used to train the second model. The trained second model may in turn act as a teacher model and its labeled training data may be used to train the first model.

The reference entity extraction model obtained through performing the above model enhancement on the complex language model can obtain accurate entity extraction results at runtime and can support multiple languages. After the reference entity extraction model is obtained, model compression may be performed with the reference entity extraction model and the lightweight language model to obtain a target entity extraction model that can be deployed on a client device. The model compression may include knowledge distillation. Knowledge distillation aims to transfer knowledge from the reference entity extraction model to the target entity extraction model through learning the output of the reference entity extraction model. An embodiment of the present disclosure proposes representation fusion based knowledge distillation. The existing knowledge distillation employs the representation output by the upper layer in the teacher model, e.g., one transformer layer in the upper part, for knowledge distillation. The representation fusion based knowledge distillation proposed by embodiments of the present disclosure may fuse together the representations output by a predetermined number of transformer layers the upper part in the teacher model, and perform knowledge distillation with the fused representation. Compared with knowledge distillation by using only the representation output by one transformer layer in the upper part in the teacher model, performing knowledge distillation by using the representations output by a number of transformer layers in the upper part may achieve a more stable effect. Model compression may also include client optimization. Client optimization may further compress the model. Client optimization may include, e.g., reducing the model vocabulary, applying model quantization to the model, optimizing the encoding language of the model, etc. The target entity extraction model obtained through the multi-stage training process described above has a performance comparable to that of the reference entity extraction model, and is able to obtain accurate entity extraction results. Moreover, the target entity extraction model is lightweight, and is able to efficiently perform entity extraction tasks with relatively low latency, and also can be deployed on a client device. Deploying and running the target entity extraction model on a client device enables user data, e.g., user browsing history, user preference settings, etc., to be processed on the client device of the user without being sent to a server. This avoids leakage of user data and enhances privacy protection for users.

Preferably, in order to further improve the efficiency of the target entity extraction model at runtime, embodiments of the present disclosure propose intelligent feature truncation. A target entity extraction model usually has a certain processing length. When the length of a text feature and the length of a visual feature exceed the processing length of the target entity extraction model, the text feature and visual feature may be intelligently truncated into a plurality of feature segments. For example, the text feature and the visual feature may be truncated into a plurality of feature segments based on semantics of a plurality of text segments in the web document. Each feature segment may include a text feature segment in the text feature and a visual feature segment corresponding to the text feature segment in the visual feature. This can ensure a text feature and a visual feature for the same text segment will not be truncated. Meanwhile, it is more efficient than the existing feature truncation method, because there are no overlapping features that need to be processed repeatedly. Additionally, in order to prevent the target entity extraction model from occupying excessive resources at runtime and affecting the performance of the client device, embodiments of the present disclosure propose limiting resource occupation of the target entity extraction model at runtime, e.g., limiting Central Processing Unit (CPU) utilization, limiting memory utilization, etc.

FIG. 1 illustrates an exemplary process 100 for entity extraction based on edge computing according to an embodiment of the present disclosure.

First, a web document 102 may be obtained. A text feature 112 of the web document 102 may be identified through a feature identifying module 110. In an implementation, a document object model tree of the web document 102 may be constructed first. Subsequently, the constructed document object model tree may be parsed to obtain a token sequence for the web document 102. The text feature 112 may be generated based on the token sequence and the location of each token of the token sequence in the token sequence.

A visual feature 114 corresponding to the text feature 112 may be identified through a feature identifying module 110. The text feature 112 may include the token sequence. Visual information corresponding to each token in the token sequence, including, e.g., location information, font shape information, font size information, font color information, etc., may be identified through the feature identifying module 110. As an example, the location information may be expressed in various ways, e.g., expressed by XY coordinate values, XPath, etc. The visual feature 114 may be obtained through rendering the web document 102.

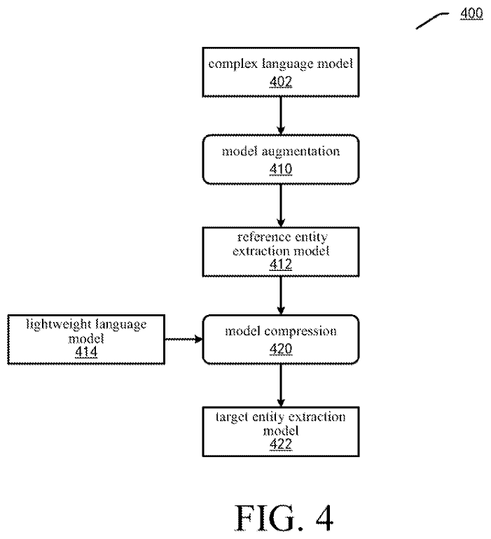

The text feature 112 and visual feature 114 may be provided to a target entity extraction model 120. The target entity extraction model 120 may run on a client device. Client device may include, e.g., desktop computer, laptop computer, tablet computer, a cellular phone, wearable device, etc. A target entity extraction model 120 may be obtained through a multi-stage training process. First, a complex language model may be obtained. Subsequently, model enhancement may be performed on the complex language model so that it can be used for performing an entity extraction task. A lightweight language model may be obtained. The lightweight language model may be a model having a lower complexity than the complex language model. Then, model compression may be performed with the reference entity extraction model and the lightweight language model to obtain the target entity extraction model 120. An exemplary process for obtaining the target entity extraction model 120 will be described later in conjunction with FIG. 4. An entity type sequence 122 corresponding to the web document 102 may be extracted through the target entity extraction model 120 based on the text feature 112 and the visual feature 114. The target entity extraction model 120 may include a text encoder 130. The text encoder 130 may generate initial text representation 132 of the text feature 112. The target entity extraction model 120 may also include a visual encoder 140. The visual encoder 140 may generate visual representation 142 of the visual feature 114. The initial text representation 132 may be provided to a set of transformer layers 150 in the target entity extraction model 120. The set of transformer layers 150 may include M (M≥1) transformer layers. The set of transformer layers 150 may generate a text representation 152 based on the initial text representation 132.

Subsequently, the text representation 152 and the visual representation 142 may be fused together and provided to the sequence label output layer 160 in the target entity extraction model 120. The sequence label output layer 160 may generate an entity type sequence 122 corresponding to the web document 102 based on the text representation 152 and the visual representation 142.

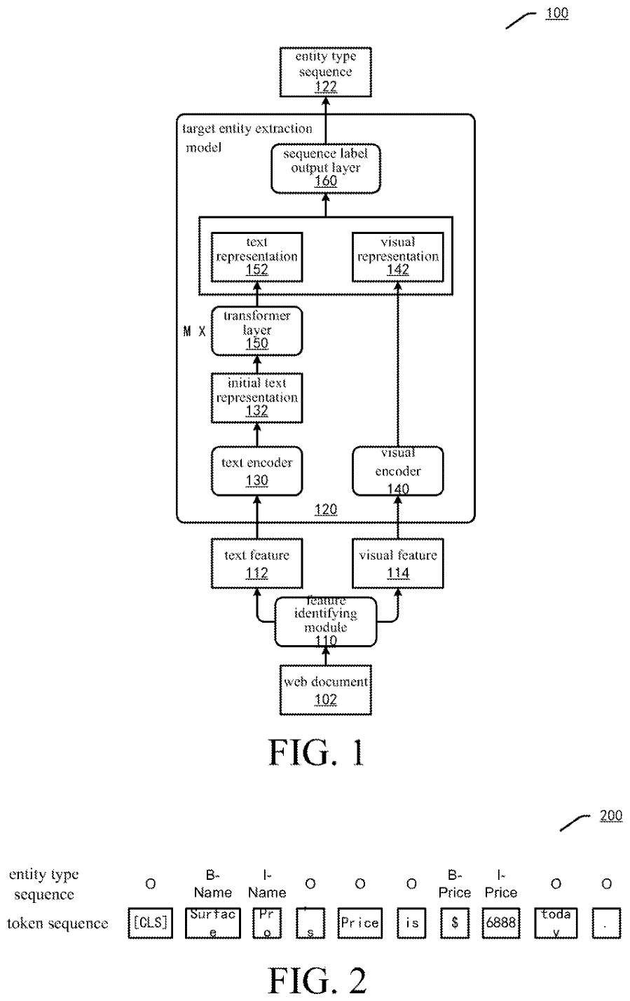

The entity type sequence 122 may correspond to a token sequence in the text feature 112 and may include an entity type corresponding to each token in the token sequence. FIG. 2 illustrates a schematic diagram 200 of an exemplary token sequence and corresponding entity type sequence according to an embodiment of the present disclosure. In the diagram 200, a token sequence may include tokens “[CLS]”, “Surface”, “Pro”, “'s”, “Price”, “is”, “S”, “6888”, “today” and”.”. The entity type sequence includes an entity type corresponding to each token in the token sequence. For example, the entity type “O” represents a non-entity label, the entity type “Bi-Name” represents the first token label with entity type “Name”, and the entity type “I-Name” represents the label of other tokens except the first token with entity type “Name”, etc.

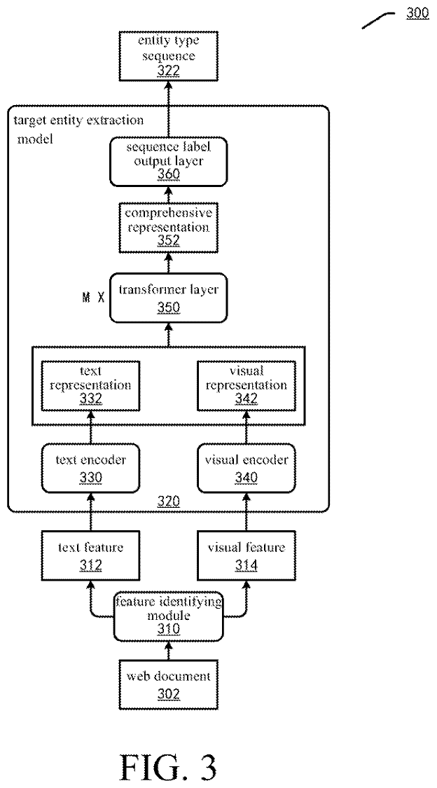

Referring back to FIG. 1, in the process 100, the text representation 152 and the visual representation 142 are fused together after a set of transformer layers 150. This approach may be referred to as late fusion. Accordingly, the process 100 employs a late fusion approach to perform the process for entity extraction based on edge computing. Other approaches may also be employed to perform the process for entity extraction based on edge computing. FIG. 3 illustrates another exemplary process 300 for entity extraction based on edge computing according to an embodiment of the present disclosure. The web document 302, feature identifying module 310, text feature 312, and visual feature 314 in FIG. 3 may correspond to the web document 102, feature identifying module 110, text feature 112, and visual feature 114 in FIG. 1, respectively.

The text feature 312 and visual feature 314 may be provided to a target entity extraction model 320. The target entity extraction model 320 may run on a client device. The target entity extraction model 320 may be obtained through a process similar to the process of obtaining the target entity extraction model 120. An entity type sequence 322 corresponding to the web document 302 may be extracted through the target entity extraction model 320 based on the text feature 312 and the visual feature 314.

The target entity extraction model 320 may include a text encoder 330. Text encoder 330 may generate text representation 332 of the text feature 312. The target entity extraction model 320 may also include a visual encoder 340. The visual encoder 340 may generate visual representation 342 of the visual feature 314.

The text representation 332 and the visual representation 342 may be fused together and provided to a set of transformer layer 350 in the target entity extraction model 320. The set of transformer layers 350 may include M transformer layers. The set of transformer layers 350 may generate a comprehensive representation 352 based on the text representation 332 and the visual representation 342.

Subsequently, the comprehensive representation 352 may be provided to the sequence label output layer 360 in the target entity extraction model 320. The sequence label output layer 360 may generate an entity type sequence 322 corresponding to the web document 302 based on the comprehensive representation 352.

Unlike the process 100 in FIG. 1, in the process 300, the text representation 352 and the visual representation 342 are fused together before the set of transformer layers 350. This approach may be referred to as early fusion. Accordingly, the process 300 employs an early fusion approach to perform the process for entity extraction based on edge computing. The process 300 performs self-attention mechanism based computation on both the text representation and the visual representation through the transformer layer, therefore, compared with the process 100, a more accurate representation of the web document may be generated, and more accurate entity extraction results may be further obtained.

In the process 100 and process 300, an entity type sequence corresponding to the web document may be extracted through the target entity extraction model based on the text feature and the visual feature of the web document. Existing entity extraction techniques only consider text features. Considering both text features and visual features of a web document when performing entity extraction for the web document enables to obtain more accurate entity extraction results. Taking price extraction as an example, a web page sometimes contains multiple prices, e.g., previous prices, current prices, prices for members, etc. These prices may have different visual features, e.g., different colors, different font sizes, etc. When performing price extraction, considering both text features and visual features enables more accurate extraction of desired prices.

It should be understood that the process for entity extraction based on edge computing described above in conjunction with FIGS. 1 to 3 is merely exemplary. According to actual application requirements, the steps in the process for entity extraction based on edge computing may be replaced or modified in any manner, and the process may include more or fewer steps. Additionally, the target entity extraction model 120 and the target entity extraction model 320 shown in FIG. 1 and FIG. 3 are only examples of target entity extraction model. A target entity extraction model may have any other structure and may include more or fewer layers depending on the actual application requirements.

A target entity extraction model, e.g., the target entity extraction model 120 and the target entity extraction model 320 in FIGS. 1 and 3, usually has a certain processing length. When the length of a text feature and the length of a visual feature exceed the processing length of the target entity extraction model, the text feature and visual feature may be truncated into a plurality of feature segments. At present, when the length of the input feature exceeds the processing length of the model, the length of each feature segment is usually determined according to the processing length, and the input feature is truncated according to the determined length. This may cause a feature corresponding to a text segment to be truncated. A text segment may be, e.g., a sentence, a phrase, etc. In order to enable the model to obtain complete features of complete text segments, sliding windows may be used to segment features, and there may be overlap between two adjacent sliding windows. However, this approach increases the processing latency of the model and reduces the working efficiency of the model due to the need to repeatedly process some features. An embodiment of the present disclosure proposes intelligent feature truncation. A text feature and a visual feature may correspond to a plurality of text segments in a web document. The text feature and the visual feature may be intelligently truncated into a plurality of feature segments based on semantics of a plurality of text segments in the web document. Each feature segment may include a text feature segment in the text feature and a visual feature segment corresponding to the text feature segment in the visual feature. This can ensure a text feature and a visual feature for the same text segment will not be truncated. Meanwhile, it is more efficient than the existing feature truncation method, because there are no overlapping features that need to be processed repeatedly. For each feature segment in the plurality of feature segments, an entity type subsequence corresponding to the feature segment may be extracted. Subsequently, a plurality of entity type subsequences corresponding to the plurality of feature segments may be combined into the entity type sequence corresponding to the web document.

Preferably, in order to prevent the target entity extraction model from occupying excessive resources at runtime and affecting the performance of the client device, embodiments of the present disclosure also propose limiting resource occupation of the target entity extraction model at runtime, e.g., limiting CPU utilization, limiting memory utilization, etc.

FIG. 4 illustrates an exemplary process 400 for obtaining a target entity extraction model according to an embodiment of the present disclosure. The process 400 is a multi-stage training process. A target entity extraction model that can be deployed on a client device, e.g., the target entity extraction model 120 in FIG. 1 and the target entity extraction model 320 in FIG. 3, may be obtained through the process 400.

First, a complex language model 402 may be obtained. As an example, the complex language model 402 may be a transformer layer structure based model. e.g., a Turing Universal Language Representing (TULR) model that includes 12 transformer layers and has a hidden embedding vector size of 768 dimensions. The complex language model 402 may be obtained through pretraining with only text corpus.

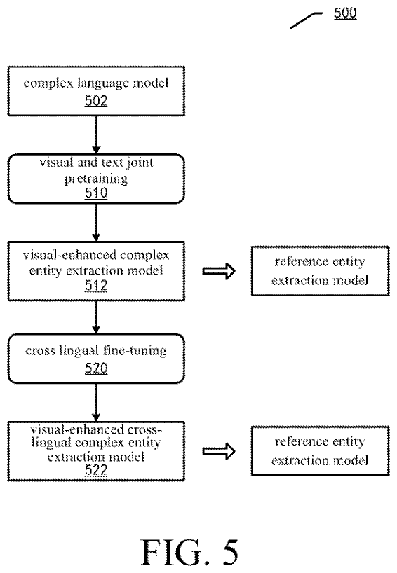

Model augmentation 410 may be performed on the complex language model to obtain a reference entity extraction model 412 that can be used to perform an entity extraction task. Model enhancement may include visual and text joint pretraining, cross lingual fine-tuning, etc. An exemplary process for performing model enhancement will be described later in conjunction with FIG. 5.

Subsequently, a lightweight language model 414 may be obtained. The lightweight language model 414 may be a model having a lower complexity than the complex language model 402. As an example, the lightweight language model 414 may be a transformer layer structure based model, but include fewer layers of transformers than the complex language model 402. For example, the lightweight language model 414 may be a tiny Cross-lingual Mini Language Model (tiny xMiniLM) trained based on a Cross-lingual Mini Language Model (xMiniLM). The tiny Cross-lingual Mini Language Model includes 6 transformer layers, with a hidden embedding vector size of 128 dimensions.

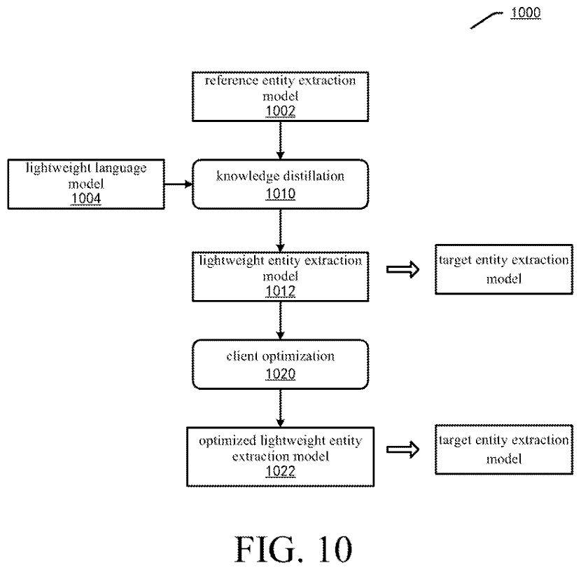

Then, model compression 420 may be performed with the reference entity extraction model 412 and the lightweight language model 414 to obtain a target entity extraction model 422 that can be deployed on a client device. An exemplary process for performing model compression will be described later in conjunction with FIG. 10.

It should be understood that the process for obtaining a target entity extraction model described above in conjunction with FIG. 4 is merely exemplary. According to actual application requirements, the steps in the process for obtaining a target entity extraction model may be replaced or modified in any manner, and the process may include more or fewer steps. Additionally, the specific order or hierarchy of the steps in the process 400 is only exemplary, and the process for obtaining a target entity extraction model may be performed in an order different from the described one.

FIG. 5 illustrates an exemplary process 500 for performing model enhancement on a complex language model according to an embodiment of the present disclosure. The process 500 may be an implementation of the model enhancement 410 in FIG. 4. A reference entity extraction model may be obtained through process 500.

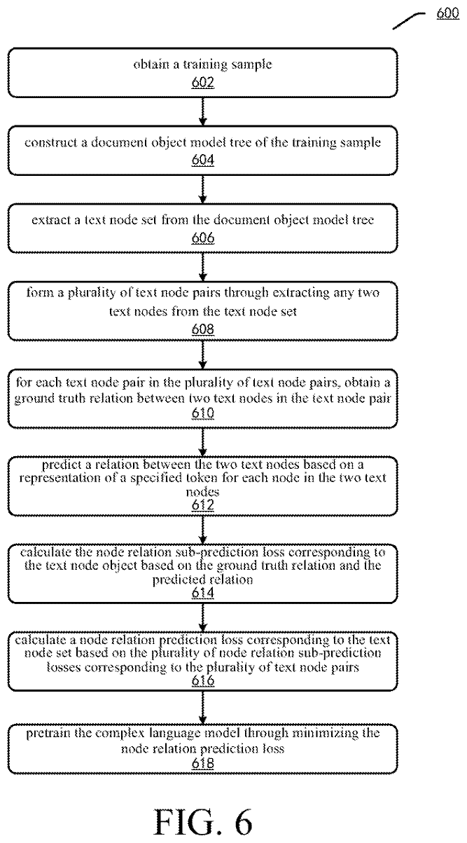

In the process 500, first, visual and text joint pretraining 510 may be performed on a complex language model 502 to obtain a visual-enhanced complex entity extraction model 512. The complex language model 502 may correspond to the complex language model 402 in FIG. 4. Visual and text joint pretraining 510 aims to enable the trained model to perform entity extraction for a web document with both text features and visual features of the web document. Visual and text joint pretraining 510 may be performed through a variety of pretraining tasks. As an example, the pretraining task may be a known Masked Language Model (MLM) pretraining task. As another example, the pretraining task may be a node relation prediction pretraining task. A document object model tree corresponding to the web document may be constructed, and a text node set may be extracted from the document object model tree. The node relation prediction pretraining task enables the model to better understand the structure of the document object model tree of a web document through modeling the node relation, and to further obtain accurate entity extraction results. An exemplary process for performing visual and text joint pretraining through node relation prediction pretraining task will be described later in conjunction with FIG. 6. Various pretraining tasks may be implemented separately or in combination with each other. The visual-enhanced complex entity extraction model 512 may be taken as the reference entity extraction model.

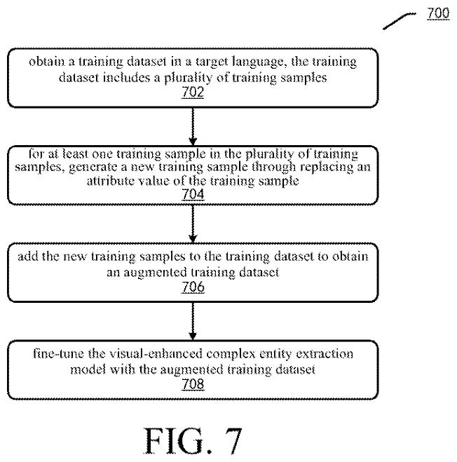

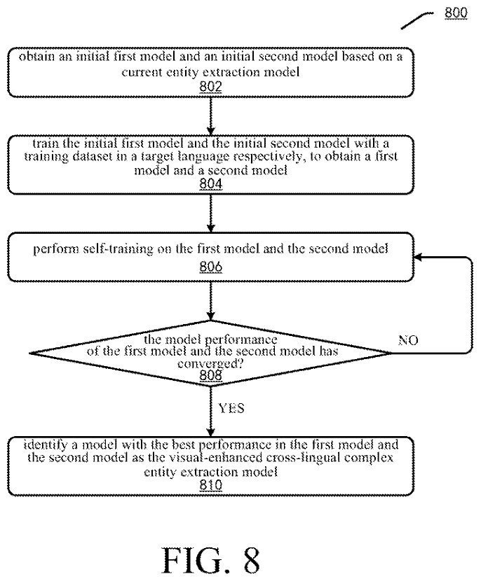

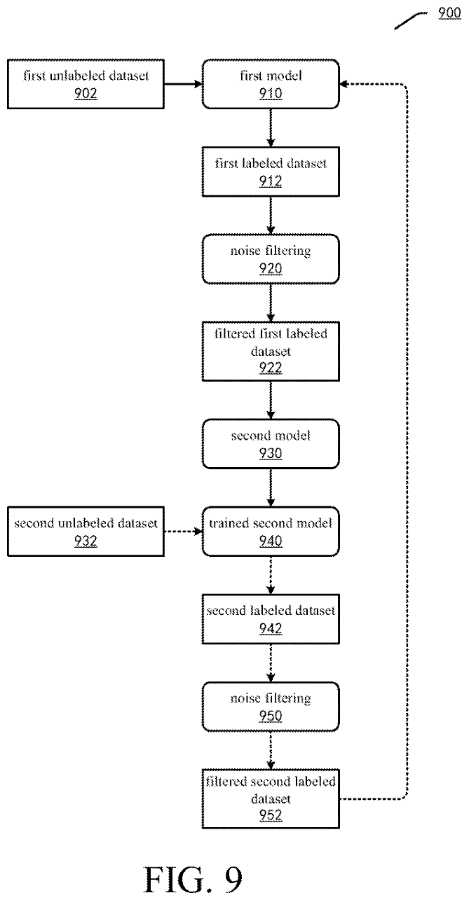

Preferably, after a visual-enhanced complex entity extraction model 512 is obtained, in order to improve the performance of the model when performing an entity extraction task for a scarce training resource language, cross lingual fine-tuning 520 may also be performed on the vision-enhanced complex entity extraction model 512, to obtain a visual-enhanced cross-lingual complex entity extraction model 522. Cross lingual fine-tuning 520 may be performed in a variety of ways. In an implementation, the cross lingual fine-tuning 520 may be performed with machine translation. For example, training samples in the source language may be translated into training samples in the target language using machine translation. The source language may be a language with rich training resources, e.g., a language with many training samples. The target language may be a scarce training resource language, e.g., a language with few training samples. In this way, the number of training samples in the target language may be increased. In an implementation, the cross lingual fine-tuning 520 may be performed through attribute augmentation. Attribute augmentation aims to augment the training dataset of the scarce training resource language through replacing attribute values of the training samples of the scarce resource language. A model trained with an augmented training dataset is more robust when performing an entity extraction task for a scarce training resource language. An exemplary process for performing cross lingual fine-tuning through attribute augmentation will be described later in conjunction with FIG. 7. In another implementation, the cross lingual fine-tuning 520 may be performed through self-training based on iterative knowledge distillation. Self-training based on iterative knowledge distillation aims to optimize two models through performing multiple rounds of self-training process on these two models. In each round, the first model may be regarded as the teacher model through knowledge distillation, and its labeled training data may be used to train the second model. The trained second model may in turn act as a teacher model and its labeled training data may be used to train the first model. An exemplary process for performing cross lingual fine-tuning through self-training based on iterative knowledge distillation will be described later in conjunction with FIGS. 8 and 9. Additionally, for some target languages, a small amount of high-quality training data may be labeled through crowd-sourcing, and the model may be enhanced through few-shot learning. Various implementations may be implemented separately or in combination with each other. In the case where cross lingual fine-tuning 520 is performed, the visual-enhanced cross-lingual complex entity extraction model 522 may be taken as the reference entity extraction model. It should be understood that the process for performing model enhancement on a complex language model described above in conjunction with FIG. 5 is merely exemplary. According to actual application requirements, the steps in the process for performing model enhancement on a complex language model may be replaced or modified in any manner, and the process may include more or fewer steps. Additionally, the specific order or hierarchy of the steps in the process 500 is only exemplary, and the process for model enhancement may be performed in an order different from the described one.

FIG. 6 illustrates an exemplary process 600 for performing visual and text joint pretraining through node relation prediction pretraining task according to an embodiment of the present disclosure. The process 600 may be an implementation of the visual and text joint pretraining 510 in FIG. 5.

At 602, a training sample may be obtained. The training sample may be a web document.

At 604, a document object model tree of the training sample may be constructed. The constructed document object model tree may include a root node, a set of element nodes and a set of text nodes.

At 606, a text node set may be extracted from the document object model tree.

At 608, a plurality of text node pairs may be formed through extracting any two text nodes from the text node set.

For each text node pair in the plurality of text node pairs, a node relation sub-prediction loss corresponding to the text node pair may be calculated. For example, at 610, a ground truth relation between two text nodes in the text node pair may be obtained. A set of relations may be pre-defined, including, e.g., self relation, parent relation, child relation, brother relation, ancestor relation, descendant relation, other relations, etc. Each text node pair may be pre-assigned with a corresponding node relation label. The node relation label may be obtained as the ground truth relation between the two text nodes in the text node pair.

At 612, a relation between the two text nodes may be predicted based on a representation of a specified token for each node in the two text nodes. As an example, the specified token may be the first token. The representation of the specified token may be a representation that fuses both the text representation and the visual representation of the token.

At 614, the node relation sub-prediction loss corresponding to the text node object may be calculated based on the ground truth relation and the predicted relation.

Steps 610 to 614 may be performed for each text node pair in the plurality of text node pairs, thereby obtaining a plurality of node relation sub-prediction losses corresponding to a plurality of text node pairs. At 616, a node relation prediction loss corresponding to the text node set may be calculated based on the plurality of node relation sub-prediction losses corresponding to the plurality of text node pairs.

At 618, the complex language model may be pretrained through minimizing the node relation prediction loss.

The process 600 enables the model to better understand the structure of the document object model tree of a web document through modeling the node relation, and to further obtain accurate entity extraction results. It should be understood that the process for performing visual and text joint pretraining through node relation prediction pretraining task described above in conjunction with FIG. 6 is merely exemplary. According to actual application requirements, the steps in the process for performing visual and text joint pretraining through node relation prediction pretraining task may be replaced or modified in any manner, and the process may include more or fewer steps. Additionally, the specific order or hierarchy of the steps in the process 600 is only exemplary, and the process for performing visual and text joint pretraining through node relation prediction pretraining task may be performed in an order different from the described one.

FIG. 7 illustrates an exemplary process 700 for performing cross lingual fine-tuning through attribute augmentation according to an embodiment of the present disclosure. The process 700 may be an implementation of the cross lingual fine-tuning 520 in FIG. 5.

At 702, a training dataset in a target language may be obtained. The target domain may be a language with scarce training resource. The training dataset may include a plurality of training samples.

At 704, for at least one training sample in the plurality of training samples, a new training sample may be generated through replacing an attribute value of the training sample. As an example, the training samples may include the prices of products. The price may be replaced with other values, so that new training samples may be generated.

At 706, the new training samples may be added to the training dataset to obtain an augmented training dataset.

At 708, the visual-enhanced complex entity extraction model may be fine-tuned with the augmented training dataset.

In the process 700, the training dataset of the scarce training resource language may be augmented through replacing attribute values of the training samples of the scarce training resource language. A model trained with an augmented training dataset is more robust when performing an entity extraction task for the scarce training resource language. It should be understood that the process for performing cross lingual fine-tuning through attribute augmentation described above in conjunction with FIG. 7 is merely exemplary. According to actual application requirements, the steps in the process for performing cross lingual fine-tuning through attribute augmentation may be replaced or modified in any manner, and the process may include more or fewer steps.

FIG. 8 illustrates an exemplary process 800 for performing cross lingual fine-tuning through self-training based on iterative knowledge distillation according to an embodiment of the present disclosure. The process 800 may be an implementation of the cross lingual fine-tuning 520 in FIG. 5.

At 802, an initial first model and an initial second model may be obtained based on a current entity extraction model. In the case where other cross lingual fine-tuning operations are not performed, the current entity extraction model may be an entity extraction model obtained through visual and text joint pretraining. In the case where other cross lingual fine-tuning operations are performed, the current entity extraction model may be an entity extraction model obtained through visual and text joint pretraining and cross lingual fine-tuning. The initial first model and the initial second model may share the same model structure.

At 804, the initial first model and the initial second model may be trained with a training dataset in a target language, respectively, to obtain a first model and a second model.

At 806, self-training may be performed on the first model and the second model. The self-training may be self-training based on iterative knowledge distillation. An exemplary process for performing self-training based on iterative knowledge distillation will be described later in conjunction with FIG. 9.

At 808, it may be determined whether the model performance of the first model and the second model has converged.

If at 808, it is determined that the model performance of the first model and the second model has not converged, the process 800 may return to 806, that is to perform self-training on the first model and the second model again.

If at 808, it is determined that the model performance of the first model and the second model has converged, then the self-training may stop and the process 800 may proceed to 810. At 810, a model with the best performance in the first model and the second model may be identified as the visual-enhanced cross-lingual complex entity extraction model.

FIG. 9 illustrates an exemplary process 900 for performing self-training based on iterative knowledge distillation according to an embodiment of the present disclosure. The process 900 may correspond to step 806 in FIG. 8.

A first unlabeled dataset 902 in the target language may be provided to a first model 910. The first unlabeled dataset 902 may include a plurality of web document samples, and each web document sample has no entity type sequence label. The first unlabeled dataset 902 may be labeled through a first model 910 to obtain a first labeled dataset 912.

Noise filtering 920 may be performed on the first labeled dataset 912 to obtain a filtered first labeled dataset 922. Noise filtering 920 may be performed in a number of ways. For example, a third model other than the first model and the second model may be trained. The first unlabeled dataset 902 may be labeled through a third model to obtain a reference labeled dataset. The first labeled dataset 912 may be compared to the reference labeled dataset. For a specific training web document sample, its first entity type sequence label in the first unlabeled dataset 902 may be compared with its reference entity type sequence label in the reference label dataset. If the two labels are not consistent or similar, the training web document sample and the corresponding first entity type sequence label may be regarded as noise and filtered out from the first unlabeled dataset 902.

Subsequently, the second model may be trained with the filtered first labeled dataset 930 to obtain a trained second model 940.

A second unlabeled dataset 932 in the target language may be provided to a trained second model 940. The second unlabeled dataset 932 may be a dataset different from the first unlabeled dataset 902. The second unlabeled dataset 932 may be labeled through a trained second model 940 to obtain a second labeled dataset 942.

Noise filtering 950 may be performed on the second labeled dataset 942 to obtain a filtered second labeled dataset 952. Noise filtering 950 may be performed in a manner similar to the manner in which noise filtering 920 is performed.

The filtered second labeled dataset 952 may be used to further train the first model 910. As such, the first model and the second model may be gradually optimized through multiple rounds of the process 900.

It should be understood that the process for performing cross lingual fine-tuning through self-training based on iterative knowledge distillation described above in conjunction with FIG. 8 and FIG. 9 is merely exemplary. According to actual application requirements, the steps in the process for performing cross lingual fine-tuning through self-training based on iterative knowledge distillation may be replaced or modified in any manner, and the process may include more or fewer steps. Additionally, the specific orders or hierarchies of the steps in the processes 800 and 900 are only exemplary, and the process for performing cross lingual fine-tuning through self-training based on iterative knowledge distillation may be performed in an order different from the described one.

The process for performing model enhancement on a complex language model to obtain a reference entity extraction model that can be used to perform an entity extraction task is described above with reference to FIGS. 5 to 9. The reference entity extraction model obtained through performing the above model enhancement on the complex language model can obtain accurate entity extraction results at runtime and can support multiple languages. Referring back to FIG. 4, after the reference entity extraction model is obtained, model compression may be performed with the reference entity extraction model and the lightweight language model to obtain a target entity extraction model that can be deployed on a client device.

FIG. 10 illustrates an exemplary process 1000 for performing model compression with a reference entity extraction model and a lightweight language model according to an embodiment of the present disclosure. The process 1000 may be an implementation of the model compression 420 in FIG. 4.

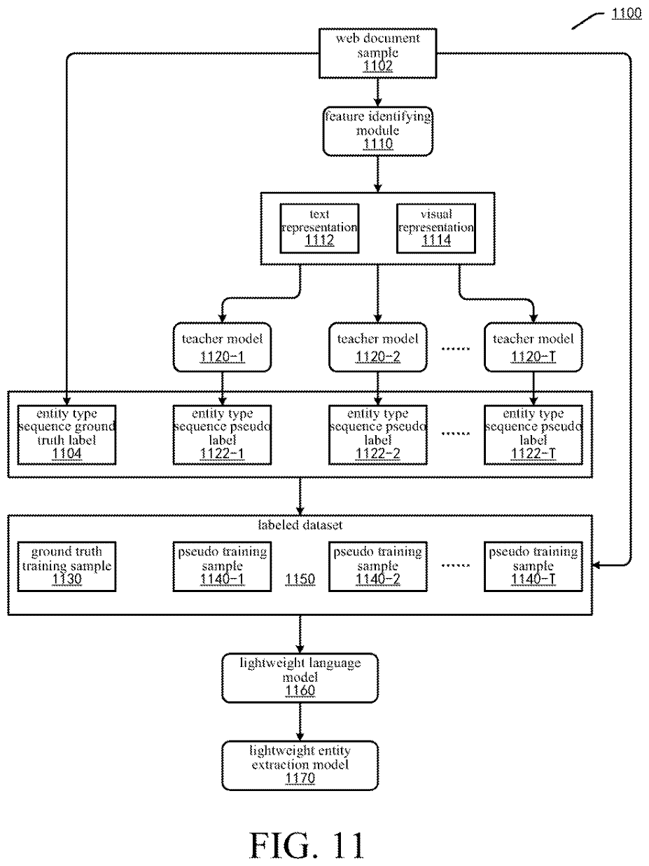

In the process 1000, first, knowledge distillation 1010 may be performed with the reference entity extraction model 1002 and the lightweight language model 1004 to obtain a lightweight entity extraction model 1012. Knowledge distillation aims to transfer knowledge from the reference entity extraction model 1002 to the target entity extraction model through learning the output of the reference entity extraction model 1002. The reference entity extraction model 1002 and the lightweight language model 1004 may correspond to the reference entity extraction model 412 and the lightweight language model 414 in FIG. 4, respectively. An embodiment of the present disclosure proposes representation fusion based knowledge distillation. The existing knowledge distillation employs the representation output by the upper layer in the teacher model, e.g., one transformer layer in the upper part, for knowledge distillation. The representation fusion based knowledge distillation proposed by embodiments of the present disclosure may fuse together the representations output by a predetermined number of transformer layers in the upper part in the teacher model, and perform knowledge distillation with the fused representation. Compared with knowledge distillation by using only the representation output by one transformer layer in the upper part in the teacher model, knowledge distillation by using the representations output by a number of transformer layers in the upper part may achieve a more stable effect. An exemplary process for performing representation fusion based knowledge distillation will be described later in conjunction with FIG. 11. The lightweight entity extraction model 1012 may be taken as a target entity extraction model.

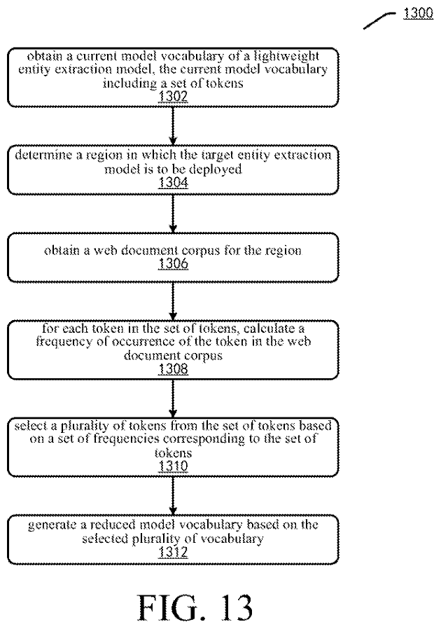

Preferably, after obtaining the lightweight entity extraction model 1012, in order to further compress the model, a client optimization 1020 may be performed on the lightweight entity extraction model 1012 to obtain an optimized lightweight entity extraction model 1022. Client optimization 1020 may be performed in a variety of ways. In an implementation, a model vocabulary of a lightweight entity extraction model 1012 may be reduced. An exemplary process for reducing a model vocabulary of a lightweight entity extraction model will be described later in conjunction with FIG. 13. In another implementation, model quantization (e.g., int8 quantization, etc.) may be applied to the lightweight entity extraction model 1012. Int8 quantization may use 8-bit integers instead of floating-point numbers, and use integer operations instead of floating-point operations, which may reduce demands of the model for both computing resources and storage resources. In yet another implementation, an encoding language for the lightweight entity extraction model 1012 may be optimized. For example, for some processes. e.g., preprocessing and tokenization process, an encoding language based on C++ may be used instead of an encoding language based on Python. These implementations may be implemented separately or in combination with each other. When the client optimization 1020 is performed, the optimized lightweight entity extraction model 1022 may be taken as the target entity extraction model.

It should be understood that the process for performing model compression with a reference entity extraction model and a lightweight language model described above in conjunction with FIG. 10 is merely exemplary. According to actual application requirements, the steps in the process for performing model compression may be replaced or modified in any manner, and the process may include more or fewer steps. Additionally, the specific order or hierarchy of the steps in the process 1000 is only exemplary, and the process for performing model compression may be performed in an order different from the described one.

FIG. 11 illustrates an exemplary process 1100 for performing representation fusion based knowledge distillation according to an embodiment of the present disclosure. The process 1100 may be an implementation of the knowledge distillation 1010 in FIG. 10.

A web document sample 1102 may be obtained. The web document sample 1102 may have a corresponding entity type sequence ground truth label 1104. The entity type sequence ground truth label 1104 may be obtained manually. The text feature 1112 and visual feature 1114 of the web document sample 1102 may be identified through the feature identifying module 1110. The operations performed by the feature identifying module 1110 may be similar to those performed by the feature identifying module 110 in FIG. 1.

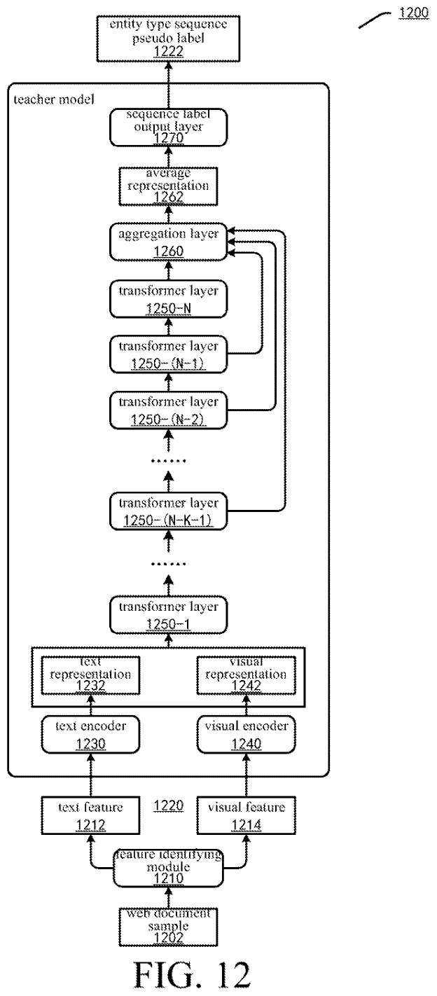

One or more teacher models, e.g., teacher model 1120-1 to teacher model 1120-T, may be obtained based on the reference entity extraction model, where T≥1. The web document sample 1102 may be labeled through the teacher model 1120-1 to the teacher model 1120-T, so as to obtain one or more entity type sequence pseudo labels corresponding to the web document sample 1102. e.g., entity type sequence pseudo label 1122-1 to entity type sequence pseudo label 1212-T. Each teacher model 1120-t (1≤t≤T) may include a plurality of transformer layers. The existing knowledge distillation employs the representation output by the upper layer in the teacher model, e.g., one transformer layer in the upper part, for knowledge distillation. An embodiment of the present disclosure proposes representation fusion based knowledge distillation. The representations output by a number of transformer layers in the upper part in the teacher model may be fused together, and knowledge distillation may be performed with the fused representation. For example, the entity type sequence pseudo label 1212-t output by the teacher model 1120-t may be generated based on a fused representation that is obtained through the representations output by a number of transformer layers located in the upper part in the teacher model 1120-t being fused together. An exemplary process for labeling a web document sample through a teacher model will be described later in conjunction with FIG. 12.

The web document sample 1102 may be combined with each of these labels respectively to form a set of training samples. For example, the web document sample 1102 and the entity type sequence ground truth label 1104 may be combined into a ground truth training sample 1130; the web document sample 1102 and the entity type sequence pseudo label 1122-1 may be combined into a pseudo training sample 1140-1; the web document sample 1102 and the entity type sequence pseudo label 1122-2 may be combined into a pseudo training sample 1140-2; the web document sample 1102 and the entity type sequence pseudo label 1122-T may be combined into a pseudo training sample 1140-T, etc. These training samples may be combined into a labeled dataset 1150. A lightweight language model 1160 may be trained with the labeled dataset 1150 to obtain a lightweight entity extraction model 1170. Preferably, the lightweight language model 1160 may include one first sequence label output layer and T second sequence label output layers. The first sequence label output layer may correspond to the entity type sequence ground truth label 1104. Each second sequence label output layer may correspond to one teacher model from the teacher models 1120-1 to 1120-T. During training, (T+1) prediction results output by one first sequence label output layer and T second sequence label output layers may be obtained. For each prediction result, the sub-prediction loss corresponding to the prediction result may be calculated with the prediction result and the corresponding entity type sequence ground truth label or entity type sequence pseudo label. (T+1) sub-prediction losses corresponding to the (T+1) prediction results may be obtained. Preferably, the (T+1) sub-prediction losses may be calculated with different loss functions. The prediction loss corresponding to the web document sample 1102 may be calculated based on the (T+1) sub-prediction losses, and the lightweight language model 1160 may be trained through minimizing the prediction loss.

It should be understood that although the entity type sequence ground truth label 1104 of the web document sample 1102 is shown in the process 1100, the process 1100 may be performed without the entity type sequence ground truth label 1104. In this case, the labeled dataset 1150 used to train the lightweight language model 1160 may not include ground truth training samples 1130, and the lightweight language model 1160 may not include the first sequence label output layer. Additionally, although a plurality of teacher models are shown in the process 1100, only one teacher model is also possible. In this case, the lightweight language model 1160 may only include one second sequence label output layer.

FIG. 12 illustrates an exemplary process 1200 for labeling a web document sample through a teacher model according to an embodiment of the present disclosure. The process 1200 may be performed through the teacher model 1220 for the web document sample 1202. The web document sample 1202 may correspond to the web document sample 1102 in FIG. 11. The teacher model 1220 may be any one of the teacher models 1120-1 to 1120-T in FIG. 11. In the process 1200, a predetermined number of representations of the web document sample 1202 output by a predetermined number of transformer layers located in the upper part of a plurality of transformer layers in the teacher model 1220 may be obtained. An entity type sequence pseudo label 1222 corresponding to the web document sample 1202 may be inferred based on the predetermined number of representations.

The text feature 1212 and visual feature 1214 of the web document sample 1202 may be identified through the feature identifying module 1210. The teacher model 1220 may include a text encoder 1230. Text encoder 1230 may generate text representation 1232 of the text feature 1212. The teacher model 1220 may also include a visual encoder 1240. The visual encoder 1240 may generate visual representation 1242 of the visual feature 1214.

The teacher model 1220 may include a set of transformer layers, e.g., transformer layers 1250-1 to 1250-N (N≥1). The text representation 1232 and visual representation 1242 may be fused together and provided to the transformer layer 1250-1. The transformer layer 1250-1 may generate an intermediate representation of the web document sample 1202 based on the text representation 1232 and the visual representation 1242 through, e.g., a self-attention mechanism. This intermediate representation may be provided to a transformer layer over the transformer layer 1250-1 and in turn generate a next intermediate representation of the web document sample 1202. A predetermined number of representations of the web document sample 1202 output by the upper predetermined number of transformer layers may be obtained. For example, K representations of the web document samples 1202 output by the upper K (1≤K≤N) transformer layers. e.g., transformer layer 1250-(N−K−1) to 1250-N, may be obtained. The obtained predetermined number of representations may be provided to an aggregation layer 1260 to obtain an average representation 1262 of the web document sample 1202. Subsequently, the sequence label output layer 1270 may generate an entity type sequence pseudo label 1222 corresponding to the web document sample 1202 based on the average representation 1262.

In the process 1200, the representations output by a number of transformer layers located in the upper part in the teacher model may be fused together, and knowledge distillation may be performed with the fused representation. Compared with knowledge distillation by using only the representation output by one transformer layer in the upper part in the teacher model, knowledge distillation by using the representations output by a number of transformer layers located in the upper part may achieve a more stable effect.

It should be understood that the process for performing representation fusion based knowledge distillation described above in conjunction with FIGS. 11 and 12 is merely exemplary. According to actual application requirements, the steps in the process for performing representation fusion based knowledge distillation may be replaced or modified in any manner, and the process may include more or fewer steps. Additionally, the specific order or hierarchy of the steps in the process 1100 and process 1200 are only exemplary, and the process for performing representation fusion based knowledge distillation may be performed in an order different from the described one.

The size of the model vocabulary is a key factor affecting the size of the model. The current model vocabulary of a lightweight entity extraction model includes approximately 250,000 tokens. For each token, there is a 128-dimensional embedding vector. These tokens are tokens in multiple languages. In order to further reduce the size of the model, embodiments of the present disclosure propose to reduce model vocabulary. Generally speaking, the languages that users of browsers in a region are capable of are limited. The region where the target entity extraction model will be deployed may be determined first, and then the model vocabulary may be reduced with the web document corpus in the region. FIG. 13 illustrates an exemplary process 1300 for reducing a model vocabulary of a lightweight entity extraction model according to an embodiment of the present disclosure. The process 1300 may be an implementation of the client optimization 1020 in FIG. 10.

At 1302, a current model vocabulary of a lightweight entity extraction model may be obtained. The current model vocabulary includes a set of tokens. The set of tokens may be for multiple languages.

At 1304, a region in which the target entity extraction model is to be deployed may be determined. At 1306, a web document corpus for the region may be obtained.

At 1308, for each token in the set of tokens, a frequency of occurrence of the token in the web document corpus for the region may be calculated.

Step 1308 may be performed for all tokens in the set of tokens, thereby obtaining a set of frequencies corresponding to the set of tokens. At 1310, a plurality of tokens may be selected from the set of tokens based on a set of frequencies corresponding to the set of tokens. For example, a plurality of tokens with higher frequencies may be selected from the set of tokens.

At 1312, a reduced model vocabulary may be generated based on the selected plurality of vocabulary.

It should be understood that the process for reducing a model vocabulary of a lightweight entity extraction model described above in conjunction with FIG. 13 is merely exemplary. According to actual application requirements, the steps in the process for reducing a model vocabulary may be replaced or modified in any manner, and the process may include more or fewer steps. Additionally, the specific order or hierarchy of the steps in the process 1300 is only exemplary, and the process for reducing a model vocabulary may be performed in an order different from the described one.

The target entity extraction model obtained through the multi-stage training process described above in conjunction with FIGS. 4 to 13 has a performance comparable to that of the reference entity extraction model, and is able to obtain accurate entity extraction results. Moreover, the target entity extraction model is lightweight, and is able to efficiently perform entity extraction tasks with low latency, and also can be deployed on a client device. Deploying and running the target entity extraction model on a client device enables user data, e.g., user browsing history, user preference settings, etc., to be processed on the client device of the user without being sent to a server. This avoids leakage of user data and enhances privacy protection for users.

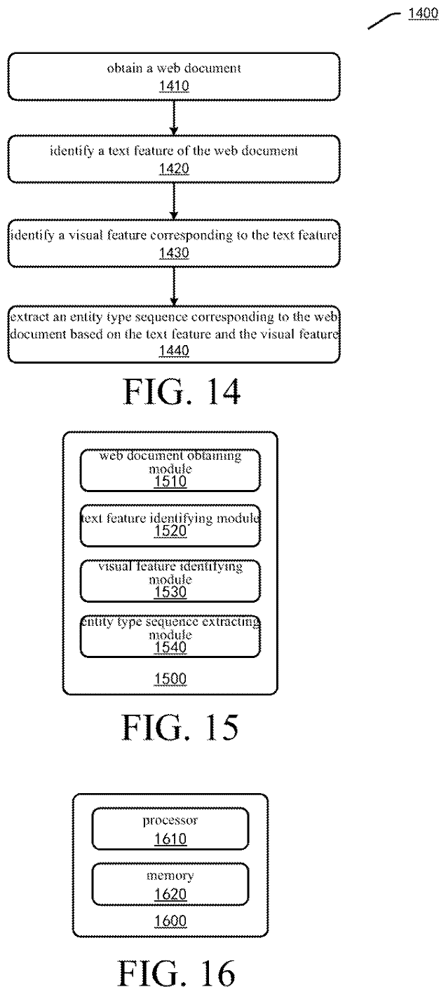

FIG. 14 is a flowchart of an exemplary method 1400 for entity extraction based on edge computing according to an embodiment of the present disclosure.

At 1410, a web document may be obtained.

At 1420, a text feature of the web document may be identified.

At 1430, a visual feature corresponding to the text feature may be identified.

At 1440, an entity type sequence corresponding to the web document may be extracted based on the text feature and the visual feature.

In an implementation, the text feature may include a token sequence. The identifying a visual feature corresponding to the text feature may comprise: identifying visual information corresponding to each token in the token sequence.

In an implementation, the text feature and the visual feature may correspond to a plurality of text segments in the web document. The extracting an entity type sequence corresponding to the web document may comprise: truncating the text feature and the visual feature into a plurality of feature segments based on semantics of the plurality of text segments; for each feature segment in the plurality of feature segments, extracting an entity type subsequence corresponding to the feature segment; and combining a plurality of entity type subsequences corresponding to the plurality of feature segments into the entity type sequence.

In an implementation, the extracting an entity type sequence corresponding to the web document may comprise: extracting, through a target entity extraction model, the entity type sequence based on the text feature and the visual feature, the target entity extraction model running on a client device.

The target entity extraction model may be obtained through: obtaining a complex language model; performing model enhancement on the complex language model, to obtain a reference entity extraction model; obtaining a lightweight language model, the lightweight language model being a model having a lower complexity than the complex language model; and performing model compression with the reference entity extraction model and the lightweight language model, to obtain the target entity extraction model.

The performing model enhancement on the complex language model may comprise: performing visual and text joint pretraining on the complex language model, to obtain a visual-enhanced complex entity extraction model; and taking the visual-enhanced complex entity extraction model as the reference entity extraction model.

The performing visual and text joint pretraining on the complex language model may comprise: obtaining a training sample; constructing a document object model tree of the training sample; extracting a text node set from the document object model tree; forming a plurality of text node pairs through extracting any two text nodes from the text node set; for each text node pair in the plurality of text node pairs, calculating a node relation sub-prediction loss corresponding to the text node pair; calculating a node relation prediction loss corresponding to the text node set based on a plurality of node relation sub-prediction losses corresponding to the plurality of text node pairs; and pretraining the complex language model through minimizing the node relation prediction loss.

The calculating a node relation sub-prediction loss corresponding to the text node pair may comprise: obtaining a ground truth relation between two text nodes in the text node pair predicting a relation between the two text nodes based on a representation of a specified token for each node in the two text nodes; and calculating the node relation sub-prediction loss based on the ground truth relation and the predicted relation.

The performing model enhancement on the complex language model further may comprise: performing cross lingual fine-tuning on the visual-enhanced complex entity extraction model, to obtain a visual-enhanced cross-lingual complex entity extraction model; and taking the visual-enhanced cross-lingual complex entity extraction model as the reference entity extraction model. The performing cross lingual fine-tuning on the visual-enhanced complex entity extraction model may comprise: obtaining a training dataset in a target language, the training dataset comprising a plurality of training samples; for at least one training sample in the plurality of training samples, generating a new training sample through replacing an attribute value of the training sample; adding the new training samples to the training dataset, to obtain an augmented training dataset; and fine-tuning the visual-enhanced complex entity extraction model with the augmented training dataset.

The performing cross lingual fine-tuning on the visual-enhanced complex entity extraction model may comprise: obtaining an initial first model and an initial second model based on a current entity extraction model; training the initial first model and the initial second model with a training dataset in a target language, respectively, to obtain a first model and a second model; performing multiple rounds of self-training on the first model and the second model; determining whether the model performance of the first model and the second model has converged; stopping the execution of the self-training in response to determining that the model performance of the first model and the second model has converged; and identifying a model with the best performance in the first model and the second model as the visual-enhanced cross-lingual complex entity extraction model.

The self-training may comprise: labeling a first unlabeled dataset in the target language through the first model, to obtain a first labeled dataset; performing noise filtering on the first labeled dataset, to obtain a filtered first labeled dataset; training a second model with the filtered first labeled dataset, to obtain a trained second model; labeling a second unlabeled dataset in the target language through the trained second model, to obtain a second labeled dataset; performing noise filtering on the second labeled dataset, to obtain a filtered second labeled dataset; and training the first model with the filtered second labeled dataset, to obtain a trained first model.

The performing model compression with the reference entity extraction model and the lightweight language model may comprise: performing knowledge distillation with the reference entity extraction model and the lightweight language model, to obtain a lightweight entity extraction model; and taking the lightweight entity extraction model as the target entity extraction model. The performing knowledge distillation with the reference entity extraction model and the lightweight language model may comprise: obtaining a web document sample; obtaining one or more teacher models based on the reference entity extraction model; labeling the web document sample through the one or more teacher models, to obtain one or more entity type sequence pseudo labels corresponding to the web document sample; combining the web document sample with the one or more entity type sequence pseudo labels and/or an entity type sequence ground truth label of the web document sample into a labeled dataset; and training the lightweight language model with the labeled dataset.

Each teacher model in the one or more teacher models may comprise a plurality of transformer layers. The labeling the web document sample through the one or more teacher models may comprise, for each teacher model: obtaining a predetermined number of representations of the web document samples output by a predetermined number of transformer layers located in the upper part of a plurality of transformer layers in the teacher model; and inferring an entity type sequence pseudo label corresponding to the web document sample based on the predetermined number of representations.

The performing model compression with the reference entity extraction model and the lightweight language model may further comprise: performing a client optimization on the lightweight entity extraction model, to obtain an optimized lightweight entity extraction model; and taking the optimized lightweight entity extraction model as the target entity extraction model.

The performing client optimization on the lightweight entity extraction model may comprise performing at least one of: reducing a model vocabulary of the lightweight entity extraction model; applying model quantization to the lightweight entity extraction model; and optimizing an encoding language for the lightweight entity extraction model.

The reducing a model vocabulary of the lightweight entity extraction model may comprise: obtaining a current model vocabulary of the lightweight entity extraction model, the current model vocabulary including a set of tokens; determining a region in which the target entity extraction model is to be deployed; obtaining a web document corpus for the region; for each token in the set of tokens, calculating a frequency of occurrence of the token in the web document corpus; selecting a plurality of tokens from the set of tokens based on a set of frequencies corresponding to the set of tokens; and generating a reduced model vocabulary based on the selected plurality of vocabulary.

It should be understood that the method 1400 may further comprise any step/process for entity extraction based on edge computing according to the embodiments of the present disclosure described above.

FIG. 15 illustrates an exemplary apparatus 1500 for entity extraction based on edge computing according to an embodiment of the present disclosure.

The apparatus 1500 may include: a web document obtaining module 1510, for obtaining a web document; a text feature identifying module 1520, for identifying a text feature of the web document; a visual feature identifying module 1530, for identifying a visual feature corresponding to the text feature; and an entity type sequence extracting module 1540, for extracting an entity type sequence corresponding to the web document based on the text feature and the visual feature. Moreover, the apparatus 1500 may further comprise any other modules configured for entity extraction based on edge computing according to the embodiments of the present disclosure described above.

FIG. 16 illustrates another exemplary apparatus 1600 for entity extraction based on edge computing according to an embodiment of the present disclosure.

The apparatus 1600 may comprise a processor 1610; and a memory 1620 storing computer-executable instructions. The computer-executable instructions, when executed, may cause the processor 1610 to: obtain a web document, identify a text feature of the web document, identify a visual feature corresponding to the text feature, and extract an entity type sequence corresponding to the web document based on the text feature and the visual feature. It should be understood that the processor 1610 may further perform any other step/process of the method for entity extraction based on edge computing according to the embodiments of the present disclosure described above. An embodiment of the present disclosure proposes a computer program product for entity extraction based on edge computing, comprising a computer program that is executed by a processor for: obtaining a web document; identifying a text feature of the web document; identifying a visual feature corresponding to the text feature; and extracting an entity type sequence corresponding to the web document based on the text feature and the visual feature. Additionally, the computer program may further be performed for implementing any other steps/processes of the method for entity extraction based on edge computing according to the embodiments of the present disclosure described above.

Embodiments of the present disclosure may be embodied in non-transitory computer-readable medium. The non-transitory computer readable medium may comprise instructions that, when executed, cause a processor to perform any operation of methods for entity extraction based on edge computing according to the embodiments of the present disclosure described above.

It should be appreciated that all the operations in the methods described above are merely exemplary, and the present disclosure is not limited to any operations or the orders of these operations in the methods, and should cover all other equivalent transformations under the same or similar concepts. Additionally, the articles “a” and “an” as used in this description and appended claims, unless otherwise specified or clear from the context that they are for the singular form, should generally be interpreted as meaning “one” or “one or more.”

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, micro-controller, digital signal processor (DSP), a field-programmable gate army (FPGA), a programmable logic device (PLD), a state machine, gated logic unit, discrete hardware circuits, and other suitable processing components configured to perform the various functions described throughout the present disclosure. The functions of a processor, any portion of a processor, or any combination of processors presented in this disclosure may be implemented with software executed by a microprocessor, a micro-controller, a DSP, or other suitable platforms.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, e.g., memory, the memory may be e.g., a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although a memory is shown separate from a processor in the various aspects presented throughout the present disclosure, the memory may be internal to the processor, e.g., a cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structurally and functionally equivalent transformations to the elements of the various aspects described throughout the present disclosure that are known or later come to be known to those of ordinary skilled in the art are expressly incorporated herein and encompassed by the claims.

1. A method for entity extraction based on edge computing, comprising:
obtaining a web document;
identifying a text feature of the web document;
identifying a visual feature corresponding to the text feature; and
extracting an entity type sequence corresponding to the web document based on the text feature and the visual feature.

2. The method of claim 1, wherein the text feature includes a token sequence, and wherein the identifying a visual feature corresponding to the text feature comprises:
identifying visual information corresponding to each token in the token sequence.

3. The method of claim 1, wherein the text feature and the visual feature correspond to a plurality of text segments in the web document, and the extracting an entity type sequence corresponding to the web document comprises:
truncating the text feature and the visual feature into a plurality of feature segments based on semantics of the plurality of text segments;
for each feature segment in the plurality of feature segments, extracting an entity type subsequence corresponding to the feature segment; and
combining a plurality of entity type subsequences corresponding to the plurality of feature segments into the entity type sequence.

4. The method of claim 1, wherein the extracting an entity type sequence corresponding to the web document comprises:
extracting, through a target entity extraction model, the entity type sequence based on the text feature and the visual feature, the target entity extraction model running on a client device.

5. The method of claim 4, wherein the target entity extraction model is obtained through:
obtaining a complex language model;
performing model enhancement on the complex language model, to obtain a reference entity extraction model;
obtaining a lightweight language model, the lightweight language model being a model having a lower complexity than the complex language model; and
performing model compression with the reference entity extraction model and the lightweight language model, to obtain the target entity extraction model.

6. The method of claim 5, wherein the performing model enhancement on the complex language model comprises:
performing visual and text joint pretraining on the complex language model, to obtain a visual-enhanced complex entity extraction model; and
taking the visual-enhanced complex entity extraction model as the reference entity extraction model.

7. The method of claim 6, wherein the performing visual and text joint pretraining on the complex language model comprises:
obtaining a training sample;
constructing a document object model tree of the training sample;
extracting a text node set from the document object model tree;
forming a plurality of text node pairs through extracting any two text nodes from the text node set;
for each text node pair in the plurality of text node pairs, calculating a node relation sub-prediction loss corresponding to the text node pair;
calculating a node relation prediction loss corresponding to the text node set based on a plurality of node relation sub-prediction losses corresponding to the plurality of text node pairs; and
pretraining the complex language model through minimizing the node relation prediction loss.

8. The method of claim 6, wherein the performing model enhancement on the complex language model further comprises:
performing cross lingual fine-tuning on the visual-enhanced complex entity extraction model, to obtain a visual-enhanced cross-lingual complex entity extraction model; and
taking the visual-enhanced cross-lingual complex entity extraction model as the reference entity extraction model.

9. The method of claim 8, wherein the performing cross lingual fine-tuning on the visual-enhanced complex entity extraction model comprises:
obtaining a training dataset in a target language, the training dataset comprising a plurality of training samples;
for at least one training sample in the plurality of training samples, generating a new training sample through replacing an attribute value of the training sample;
adding the new training samples to the training dataset, to obtain an augmented training dataset; and
fine-tuning the visual-enhanced complex entity extraction model with the augmented training dataset.

10. The method of claim 8, wherein the performing cross lingual fine-tuning on the visual-enhanced complex entity extraction model comprises:
obtaining an initial first model and an initial second model based on a current entity extraction model,
training the initial first model and the initial second model with a training dataset in a target language, respectively, to obtain a first model and a second model;
performing multiple rounds of self-training on the first model and the second model;
determining whether the model performance of the first model and the second model has converged;
stopping the execution of the self-training in response to determining that the model performance of the first model and the second model has converged; and
identifying a model with the best performance in the first model and the second model as the visual-enhanced cross-lingual complex entity extraction model.

11. The method of claim 5, wherein the performing model compression with the reference entity extraction model and the lightweight language model comprises:
performing knowledge distillation with the reference entity extraction model and the lightweight language model, to obtain a lightweight entity extraction model; and
taking the lightweight entity extraction model as the target entity extraction model.

12. The method of claim 11, wherein the performing model compression with the reference entity extraction model and the lightweight language model further comprises
performing a client optimization on the lightweight entity extraction model, to obtain an optimized lightweight entity extraction model; and
taking the optimized lightweight entity extraction model as the target entity extraction model.

13. The method of claim 12, wherein the performing client optimization on the lightweight entity extraction model comprises performing at least one of:
reducing a model vocabulary of the lightweight entity extraction model;
applying model quantization to the lightweight entity extraction model; and
optimizing an encoding language for the lightweight entity extraction model.

14. An apparatus for entity extraction based on edge computing, comprising:
a processor; and
a memory storing computer-executable instructions that, when executed, cause the processor to:
obtain a web document,
identify a text feature of the web document,
identify a visual feature corresponding to the text feature, and
extract an entity type sequence corresponding to the web document based on the text feature and the visual feature.

15. A computer program product for entity extraction based on edge computing, comprising a computer program that is executed by a processor for:
obtaining a web document;
identifying a text feature of the web document;
identifying a visual feature corresponding to the text feature; and
extracting an entity type sequence corresponding to the web document based on the text feature and the visual feature.
